(19) United States
(12) Patent Application Publication
(10) Pub. No.: US 2024/0196977 A1
(43) Pub. Date: Jun. 20, 2024

(54) HEATER ASSEMBLY HAVING A SEALED AIRFLOW PATHWAY

(71) Applicant: Philip Morris Products S.A., Neuchatel (CH)

(72) Inventors: Michel BESSANT, Neuchatel (CH); Sébastien CAPELLI, Cernier (CH); Eva SAADE LATORRE, Colombier (CH); Jun Wei YIM, Colombier (CH); Enrico TURRINI, Neuchatel (CH); Jun Jie HOW, Muar (MY)

(73) Assignee: Philip Morris Products S.A., Neuchatel (CH)

(21) Appl. No.: 18/552,232

(22) PCT Filed: Apr. 1, 2022
(86) PCT No.: PCT/EP2022/058809

§ 371 Date: Sep. 25, 2023

(30) Foreign Application Priority Data
Apr. 1, 2021 (EP) 21166787.8

(51) Int. Cl. A24F 40/46; A24F 40/20; A24F 40/485; A24F 40/70

(52) U.S. Cl. CPC A24F 40/46; A24F 40/485; A24F 40/70; A24F 40/20

(57) ABSTRACT

A heater assembly for an aerosol-generating device is provided, the heater assembly including: a first heater casing including an air inlet; a second heater casing including an aerosol outlet; and a heating chamber configured to heat an aerosol-forming substrate, the heating chamber being in fluid communication with both the air inlet and the aerosol outlet and being configured to define an airflow pathway through the heater assembly; a heater mount, the heating chamber being mounted on the heater mount; and a seal configured to seal the airflow pathway, the seal being mounted on the heater mount such that the seal is spaced apart from the heating chamber, and the seal being mounted on a first end of the heater mount and the heating chamber is mounted on a second end of the heater mount, the second end being axially opposite the first end.

The present disclosure relates to a heater assembly for an aerosol-generating device. The present disclosure further relates to an aerosol-generating device comprising a heater assembly. In particular, but not exclusively, the present disclosure relates to a handheld electrically operated aerosol-generating device for heating an aerosol-forming substrate to generate an aerosol and for delivering the aerosol into the mouth of a user. The present invention also relates to an aerosol-generating system comprising an aerosol-generating device and an aerosol-forming substrate.

Aerosol generating devices which heat an aerosol-forming substrate to produce an aerosol without burning the aerosol-forming substrate are known in the art. The aerosol-forming substrate is typically provided within an aerosol-generating article, together with other components such as filters. The aerosol-generating article may have a rod shape for insertion of the aerosol-generating article into a heating chamber of the aerosol-generating device. A heating element is typically arranged in or around the heating chamber for heating the aerosol-forming substrate once the aerosol-generating article is inserted into the heating chamber of the aerosol-generating device.

The heating chamber may be arranged within a housing of the aerosol-generating device and form part of an airflow pathway through the aerosol-generating device. It is known to provide seals around the airflow pathway and between the heating chamber and the housing to seek to prevent aerosol from leaking out of the airflow pathway and into other parts of the aerosol-generating device, which may cause damage to the electronics of the device. The seals may be placed in direct contact with the heating chamber and consequently are generally formed from a heat resistant polymer such as silicone or polysiloxane. However, exposing such polymer seals to the heating temperatures of the heating chamber may generate undesirable by-products which may contaminate the aerosol. Furthermore, such heating temperatures may degrade the seals over time.

To heat the heating chamber, an aerosol-generating device may comprise a flexible heating element arranged around the heating chamber. To allow for direct contact between the seals and the heating chamber and reduce heating of the seals, attempts have been made to distance the seals from the heating element, for example, at a downstream end of the heating chamber. However, this may result in having to compromise on the overall dimensions of the aerosol-generating device, for example, through use of a longer heating chamber, which increases the energy consumption of the heating chamber and reduces the efficiency of the aerosol-generating device. Furthermore, increasing the length of the heating chamber may result in the heating chamber surrounding other components of the aerosol-generating article, such as filters, which may be heated indirectly through heat conduction through the heating chamber. Undesirably, heating of filters wastes energy.

As an alternative to increasing the length of the heating chamber, the length of the heating element surrounding the heating chamber may be decreased. However, this may result in a portion of the aerosol-forming substrate not being covered or surrounded by the heating element such that heat has to travel a longer distance along a length of the heating chamber to heat this portion of the aerosol-forming substrate compared to travelling a relatively short distance through the thickness of the heating chamber wall. Therefore, a portion of the aerosol-forming substrate which is not surrounded by the heating element may be heated less effectively than a portion which is surrounded by the heating element. Consequently, a portion of the aerosol-forming substrate which is not surrounded by the heating element may be at a lower temperature than a portion which is surrounded by the heating element, which may result in aerosol condensing prematurely in the cooler portion. This can result in less aerosol being delivered to a user.

A further disadvantage of using polymer seals between the heating chamber and a housing of the device is that they provide a heat conduction path, which transfers heat away from the heating chamber to the materials surrounding the heating chamber. This lost heat reduces the heat available for heating the aerosol-forming substrate and reduces the efficiency of the aerosol-generating device.

An additional problem encountered with sealing airflow pathways within aerosol-generating devices is manufacturing tolerances. Variation in the dimensions of components due to manufacturing tolerances may result in poor engagement between components and potentially gaps through which aerosol may leak. Achieving a good sealing engagement between components typically requires strict manufacturing tolerances which may be difficult to achieve in rapid manufacturing processes such as injection moulding.

It would be desirable to provide a heater assembly for an aerosol-generating device having improved sealing of its airflow pathway. It would be desirable to provide a heater assembly for an aerosol-generating device which is more energy efficient and improves the delivery of aerosol to a user. It would be desirable to provide a heater assembly for an aerosol-generating device which is better able to absorb manufacturing tolerances.

According to an example of the present disclosure, there is provided a heater assembly for an aerosol-generating device. The heater assembly may comprise a first heater casing. The first heater casing may comprise an air inlet. The heater assembly may comprise a second heater casing. The second heater casing may comprise an aerosol outlet. The heater assembly may comprise a heating chamber for heating an aerosol-forming substrate. The heating chamber may be in fluid communication with the air inlet. The heating chamber may be in fluid communication with the aerosol outlet. The heating chamber may be in fluid communication with both the air inlet and aerosol outlet to define an airflow pathway through the heater assembly. The heater assembly may comprise a heater mount. The heating chamber may be mounted on the heater mount. The heater assembly may comprise a seal for sealing the airflow pathway. The seal may be mounted on the heater mount. The seal may be spaced apart from the heating chamber.

According to an example of the present disclosure, there is provided a heater assembly for an aerosol-generating device. The heater assembly comprises: a first heater casing comprising an air inlet; a second heater casing comprising an aerosol outlet; and a heating chamber for heating an aerosol-forming substrate, the heating chamber being in fluid communication with both the air inlet and aerosol outlet to define an airflow pathway through the heater assembly. The heater assembly further comprises a heater mount. The heating chamber is mounted on the heater mount. The heater assembly further comprises a seal for sealing the airflow pathway. The seal is mounted on the heater mount such that it is spaced apart from the heating chamber.

An advantage of mounting the seal on the heater mount rather than the heating chamber is that it avoids contact between the seal and the heating chamber. Furthermore, the seal is advantageously mounted on the heater mount such that it is spaced apart or distanced from the heating chamber. This distance between the heating chamber and the seal means that the seal is maintained at a lower temperature than the heating chamber and does not overheat. Since the seal is not subjected to high thermal stresses an improved sealing of the airflow pathway through the heater assembly may be achieved.

A further advantage of mounting the seal on the heater mount rather than the heating chamber is that space is not required at the ends of the heating chamber to allow for direct contact between the polymer seals and the heating chamber. Any space at one or more ends of the heating chamber, for example, to avoid direct contact between the heating element and the surrounding heater casings, can be significantly reduced. This means that shorter heating chambers can be used and a greater proportion of the length of the heating tube can be heated. This allows for more efficient heating of the aerosol-forming substrate.

The heater assembly of the present disclosure is also less susceptible to manufacturing tolerances because the seal is able to absorb at least a portion of the manufacturing tolerances to achieve improved sealing, as discussed in more detail below.

The aerosol outlet may be an opening for receiving an aerosol-generating article. Aerosol may exit the opening via an aerosol-generating article received in the heating chamber.

The first and second heater casings may be attached to each other. The first and second heater casings may enclose the heating chamber and heater mount. The seal may be arranged between the heater mount and an internal surface of one of the first and second heater casings. This arrangement provides a seal between the heater mount and one of the first and second heater casings to effectively seal at least a portion of the airflow pathway through the heater assembly to inhibit aerosol from leaking out of the airflow pathway into the aerosol-generating device.

The first and second heater casings may be attached to each other by a fastener. The first and second heater casings may be attached to each other by a plurality of fasteners. The plurality of fasteners may be symmetrically spaced around the first and second heater casings. The fastener or plurality of fasteners may comprise a threaded fastener such as a screw. The fastener or plurality of fasteners may comprise a snap-fit fastener.

The first and second heater casings may be radially spaced from the heating chamber and heater mount to define a hollow airspace around the heating chamber and heater mount. Advantageously, the hollow airspace helps to thermally insulate the heating chamber which helps to reduce heat losses from the heating chamber and also helps to reduce heat transfer to an exterior of the heater assembly.

Optionally, the seal may be arranged between the heater mount and an internal surface of the first heater casing. Alternatively, the seal may be arranged between the heater mount and an internal surface of the second heater casing.

The seal may be mounted on a first side of the heater mount. The heating chamber may be mounted on a second side of the heater mount. The second side may be axially opposite the first side. The seal may be mounted on a first end of the heater mount. The heating chamber may be mounted on a second end of the heater mount. The second end may be axially opposite the first end. An advantage of mounting the seal on an axially opposite side or end of the heater mount to the first side or end is that the seal can exert an axial force on the heater mount which, in turn, can exert an axial force on the heating chamber. By exerting an axial force, the heating chamber and heater mount are forced into engagement with each other sealing the airflow pathway at the intersection between the heater mount and the heating chamber. Furthermore, the axial force is transmitted along the length of the airflow pathway, for example, to the points where the heater mount and heating chamber are connected to internal surfaces of the first and second heater casings. Therefore, the seal helps to provide a seal at these connection points also to seal along the length of the airflow pathway and to inhibit aerosol from leaking out of the airflow pathway into the aerosol-generating device.

A further advantage of mounting the seal on an axially opposite side of the heater mount to the first side is that the seal can help to absorb manufacturing tolerances. For instance, the seal can help to absorb axial or lengthwise tolerances. As used herein, the term “axial tolerance” or “lengthwise tolerance” is used to describe manufacturing tolerances in a direction substantially parallel to the main longitudinal axis or length of the heater assembly or aerosol-generating device, for example, tolerances which result in components being longer or shorter than their specified design length. Axial or lengthwise tolerances are sometimes termed “vertical tolerances”. In addition, the seal can also help to absorb tilt tolerances. As used herein, the term “tilt tolerance” is used to describe manufacturing tolerances which cause components to tilt relative to the main longitudinal axis or length of the heater assembly or aerosol-generating device, for example, if one side of a support is at different level or axial position to another side of a support causing the component it supports to tilt.

The seal helps to absorb manufacturing tolerances in various ways. For example, if a component such as the heating chamber is too short, the thickness of the seal may compensate for the shortage in length of the heating chamber and force the heater mount into engagement with the heating chamber to close any gap which may otherwise arise. If a component such as the heating chamber is too long, the seal may be compressed to accommodate the excess length. If a point on the surface of the heater mount on which the heating chamber is mounted is at a different level or axial position to another point on the same surface causing the heating chamber to tilt when mounted, at least part of the seal may be compressed to allow the heating chamber to be aligned correctly.

The heater mount may be arranged upstream of, or distal to, the heating chamber. The terms “distal”, “upstream” “proximal” and “downstream” are used to describe the relative positions of components, or portions of components, of an aerosol-generating device and aerosol generating article. Aerosol generating articles and devices according to the present disclosure have a proximal end through which, in use, an aerosol exits the article or device for delivery to a user, and have an opposing distal end. The proximal end of the aerosol generating article and device may also be referred to as the mouth end. In use, a user draws on the proximal end of the aerosol generating article in order to inhale an aerosol generated by the aerosol generating article or device. The terms upstream and downstream are relative to the direction of aerosol movement through the aerosol generating article or aerosol-generating device when a user draws on the proximal end of the aerosol-generating article. The proximal end of the aerosol-generating article is downstream of the distal end of the aerosol-generating article. The proximal end of the aerosol-generating article may also be referred to as the downstream end of the aerosol-generating article and the distal end of the aerosol-generating article may also be referred to as the upstream end of the aerosol-generating article.

Advantageously, by arranging the heater mount upstream of, or distal to, the heating chamber, the amount of heated aerosol that will travel from the heating chamber to the heater mount is reduced because aerosol will tend to travel in the direction of the airflow pathway through the heater assembly, that is, from the heating chamber to the aerosol outlet, which is arranged downstream of the heating chamber. This arrangement therefore reduces heat transfer to the heater mount and helps to maintain the seal at a lower temperature than the heating chamber.

The heater mount may comprise a polymer. Polymers generally have lower values of thermal conductivity compared to the material from which the heating chamber is formed which is typically a metal or metal alloy. A heater mount comprising, or formed from, a polymer helps to reduce heat transfer to the seal to maintain the seal at a lower temperature than the heating chamber.

The seal may be arranged at a distance of at least 2 millimetres from the heating chamber. The seal may be arranged at a distance of at least 4 millimetres from the heating chamber. The seal may be arranged at a distance of about 6 millimetres from the heating chamber. The seal may be arranged at a distance of between 2 millimetres and 6 millimetres from the heating chamber and preferably at a distance between 4 millimetres and 6 millimetres from the heating chamber.

The seal may be resilient. The seal may be formed from any suitable material. The seal may comprise a resilient material. The seal may comprise a polymer. The seal may comprise an elastomeric polymer. The seal may comprise, or be formed from, any suitable polymer including, but not limited to, ethylene propylene diene monomer (EPDM) rubber or silicone.

The seal may be compressed when the heater assembly is assembled. The seal may be compressed between the heater mount and the first heater casing when the heater assembly is assembled.

The seal may have a Shore hardness between 30 A and 90 A, preferably a Shore hardness between 50 A and 80 A and more preferably a Shore hardness of about 70 A. These values of Shore hardness have been found to be soft enough to absorb lengthwise and tilt tolerances but still hard enough to provide sufficient force to the heater assembly for airflow pathway sealing and heater assembly integrity.

The seal may comprise any suitable shape. The seal may comprise a shape which conforms to a shape of the heater mount. The seal may comprise a shape which conforms to a shape of one of the first or second heater casings. The seal may comprise an O-ring. The seal may have any suitable cross-sectional shape in a longitudinal plane of the heater assembly including, but not limited to, a circular, cross-sectional shape or a cross-sectional shape with two opposing flat surfaces such as a square or rectangular cross-sectional shape.

The seal may have an uncompressed thickness or diameter of between 0.5 millimetres and 2 millimetres. The seal may have an uncompressed thickness or diameter of about 1 millimetre. These uncompressed thicknesses have been found to be particularly effective for absorbing lengthwise and tilt tolerances and for providing airflow pathway sealing and heater assembly integrity.

The first heater casing may have an airflow channel. The airflow channel of the first heater casing may be in fluid communication with the air inlet. The second heater casing may have an airflow channel. The airflow channel of the second heater casing may be in fluid communication with the aerosol outlet. The heating chamber may have an airflow channel. The airflow channel of the heating chamber may pass through the length of the heating chamber. The heater mount may have an airflow channel. The airflow channel of the heater mount may pass through a thickness or length of the heater mount. The airflow channels of each of the first heating casing, second heater casing, heating chamber and heater mount may be in fluid communication with each other to define the airflow pathway through the heater assembly.

The heating chamber may comprise a tubular heating chamber. A diameter of the tubular heating chamber at a first end of the tubular heating chamber may be greater than a diameter along the length of the tubular heating chamber. A diameter of the tubular heating chamber at a second end of the tubular heating chamber may be greater than a diameter along the length of the tubular heating chamber. A diameter of the tubular heating chamber at each end of the tubular heating chamber may be greater than a diameter in a region between the two ends of the tubular heating chamber.

Advantageously, making the diameter of one or both ends of the tubular heating chamber greater than the diameter of the tubular heating chamber along the length of the heating chamber, for example, in the region between the two ends of the tubular heating chamber, allows for greater manufacturing tolerances for the heating chamber and also for the other components of the heater assembly. In particular, it allows for greater radial or lateral tolerances. As used herein, the terms “radial tolerance” or “lateral tolerance” are used to describe manufacturing tolerances in a direction substantially perpendicular to the main longitudinal axis or length of the heater assembly or aerosol-generating device, for example, tolerances which result in components being wider or narrower than their specified design width or diameters being greater or less than their specified design diameter. Radial or lateral tolerances are sometimes referred to as “horizontal tolerances”.

Advantageously, by making an end diameter of the tubular heating chamber greater than other parts of the tubular heating chamber, the internal diameter at one or both ends of the tubular heating chamber will be greater than the internal diameter of the airflow pathway in other components of the heater assembly that the tubular heating chamber engages, for example, the second heater casing or the heater mount. This helps to avoid an end surface of the tubular heating chamber protruding or encroaching into the internal space of the airflow pathway, which can potentially cause damage to the aerosol-generating article when it is received into the heating chamber via the airflow pathway and may leave less end surface of the tubular heating chamber to provide sealing engagement with other components. This arrangement also allows for greater radial or lateral tolerances in the other components, which is described in more detail below.

An external diameter of one or both ends of the tubular heating chamber may be up to 20 percent larger, preferably up to 15 percent larger, more preferably up to 12 percent larger, and even more preferably up to 8 percent larger than an external diameter of a portion of the tubular heating chamber between the two ends of the tubular heating chamber. The external diameter of one or both ends of the tubular heating chamber may be between 1 percent and 20 percent larger, between 1 percent and 15 percent larger, between 1 percent and 12 percent larger, or between 1 percent and 8 percent larger than an external diameter of a portion of the tubular heating chamber between the two ends of the tubular heating chamber.

One or both ends of the tubular heating chamber may have an external diameter of between 7.5 millimetres and 9.0 millimetres, preferably between 8.0 millimetres and 8.5 millimetres and more preferably about 8.4 millimetres. A portion of the tubular heating chamber between the two ends of the tubular heating chamber may have an external diameter of between 6.5 millimetres and 8.0 millimetres, preferably between 7.0 millimetres and 8.0 millimetres and more preferably about 7.5 millimetres.

An internal diameter of the heating chamber may substantially correspond, or be substantially equal, to an external diameter of an aerosol-generating article. In some embodiments, an internal diameter of the heating chamber may be slightly smaller than the external diameter of an aerosol-generating article, such that the aerosol-generating article is compressed in the heating chamber. For example, the external diameter of an aerosol-generating article may be about 7.4 millimetres, and the internal diameter of the heating chamber may be about 7.3 millimetres. A length of the heating chamber may substantially correspond, or be substantially equal, to a length of an aerosol-forming substrate provided in an aerosol-generating article.

At least one end portion of the tubular heating chamber may be flared or funnel-shaped. A portion of the tubular heating chamber at both ends of the tubular heating chamber may be flared or funnel-shaped. The axial length of a flared or funnel-shaped end portion of the tubular heating chamber may be between 0.5 percent and 10 percent of the overall length of the tubular heating chamber, preferably between 1 percent and 5 percent of the overall length of the tubular heating chamber and more preferably about 3.3 percent of the overall length of the tubular heating chamber.

The axial length of a flared or funnel-shaped end portion of the tubular heating chamber may be between 0.2 millimetres and 2 millimetres, preferably between 0.4 millimetres and 1 millimetre and more preferably about 0.5 mm. The flared or funnel-shaped end portion or end portions of the tubular heating chamber may be arranged at an angle between 30 and 60 degrees, between 40 and 50 degrees, or at an angle of about 45 degrees to the longitudinal axis of the heating chamber or heater assembly. In some preferred embodiments, the flared or funnel-shaped end portion or end portions of the tubular heating chamber may be arranged at an angle of less than 50 degrees, preferably less than 40 degrees, or more preferably less than 30 degrees to the longitudinal axis of the heating chamber or heater assembly.

Advantageously, providing the flared or funnel-shaped end portion or end portions of the tubular heating chamber at an angle of less than 30 degrees to the longitudinal axis of the heating chamber or heater assembly may provide optimal rigidity for the flared or funnel-shaped end portion or end portions of the tubular heating chamber in the direction of the longitudinal axis of the heating chamber or heater assembly.

At least one end or end portion of the tubular heating chamber may have a stepped profile or be joggled. A portion of the tubular heating chamber at both ends of the tubular heating chamber may have a stepped profile or be joggled. The axial length of a stepped or joggled end portion of the tubular heating chamber may be between 0.5 percent and 10 percent of the overall length of the tubular heating chamber, preferably between 1 percent and 5 percent of the overall length of the tubular heating chamber and more preferably about 3.7 percent of the overall length of the tubular heating chamber. Preferably, a radius is provided between the stepped or joggled portions to avoid sharp edges and stress concentrators.

The axial length of a flared or funnel-shaped end portion of the tubular heating chamber may be between 0.2 millimetres and 2 millimetres, preferably between 0.4 millimetres and 1 millimetre and more preferably about 0.5 mm.

The tubular heating chamber may have a tubular wall thickness of between 0.05 millimetres and 1.00 millimetres, preferably between 0.05 millimetres and 0.50 millimetres and more preferably about 0.10 millimetres.

The heating chamber may be made from any suitable material including, but not limited to, a ceramic or metal or metal alloy. An example of a suitable material is stainless steel.

The heater assembly may comprise at least one electric heating element for heating an aerosol-forming substrate. The heater assembly may comprise a plurality of electric heating elements. The electric heating element or elements may be arranged around or circumscribe an external surface of the heating chamber. The electric heating element or elements may be arranged around or circumscribe an internal surface of the heating chamber. The electric heating element or elements may be part of, or integral to, the heating chamber.

The electric heating element or elements may comprise an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum and metals from the platinum group. Examples of suitable metal alloys include stainless steel, nickel-, cobalt-, chromium-, aluminium- titanium- zirconium-, hafnium-, niobium-, molybdenum-, tantalum-, tungsten-, tin-, gallium-, manganese-, gold- and iron-containing alloys, and super-alloys based on nickel, iron, cobalt, stainless steel, Timetal™, Kanthal™ and other iron-chromium-aluminium alloys, and iron-manganese-aluminium based alloys. In composite materials, the electrically resistive material may optionally be embedded in, encapsulated or coated with an insulating material or vice-versa, depending on the kinetics of energy transfer and the external physicochemical properties required.

The one or more heating elements may be formed using a metal or metal alloy having a defined relationship between temperature and resistivity. Heating elements formed in this manner may be used to both heat and monitor the temperature of the heating element during operation.

The heating element may be deposited in or on a rigid carrier material or substrate. The heating element may be deposited in or on a flexible carrier material or substrate. The heating element may be formed as a track on a suitable insulating material, such as ceramic or glass or polyimide film. The heating element may be sandwiched between two insulating materials.

The heater assembly may comprise a flexible heating element arranged around or circumscribing an external surface of the heating chamber. The flexible heating element may have a length substantially equal to the length of the aerosol-forming substrate provided in the aerosol-generating article. The heating chamber may be longer than the heating element. The heating chamber may have at least one end portion which is not covered or circumscribed by the heating element. An end portion may be provided at both ends of the heating chamber which is not covered or circumscribed by the heating element. The end portion or portions may act as spacer portions to prevent direct contact between the heating element and other components of the heater assembly. The end portion or portions may each have a length of less than 2 millimetres, preferably less than 1 millimetre and preferably about 0.5 millimetres. Advantageously, the spacer portions will be at a lower temperature during heating than the portion of the heating chamber covered or circumscribed by the heating element. The spacer portions may comprise the funnel-shaped end portions or the stepped end portions.

The heating chamber may be configured to receive at least a portion of an aerosol-generating article (as defined below).

According to an example of the present disclosure, there is provided an aerosol-generating device. The aerosol-generating device may comprise a heater assembly according to any of the heater assemblies described above. The aerosol-generating device may comprise a power supply or power source for supplying electrical power to the heater assembly.

According to an example of the present disclosure, there is provided an aerosol-generating device. The aerosol-generating device comprises a heater assembly according to any of the heater assemblies described above and a power supply or power source for supplying electrical power to the heater assembly.

The power supply may be any suitable power supply, for example a DC voltage source.

In one embodiment, the power supply is a Lithium-ion battery. Alternatively, the power supply may be a Nickel-metal hydride battery, a Nickel cadmium battery, or a Lithium based battery, for example a Lithium-Cobalt, a Lithium-Iron-Phosphate or a Lithium-Polymer battery.

The aerosol-generating device is preferably a handheld aerosol-generating device that is comfortable for a user to hold between the fingers of a single hand.

The aerosol-generating device may further comprise control circuitry configured to control a supply of electrical power to the heater assembly. The control circuitry may comprise a microprocessor. The microprocessor may be a programmable microprocessor, a microcontroller, or an application specific integrated chip (ASIC) or other electronic circuitry capable of providing control. The control circuitry may comprise further electronic components.

For example, in some embodiments, the control circuitry may comprise any of: sensors, switches, display elements. Power may be supplied to the heater assembly continuously following activation of the device or may be supplied intermittently, such as on a puff-by-puff basis. The power may be supplied to the heater assembly in the form of pulses of electrical current, for example, by means of pulse width modulation (PWM).

The aerosol-generating device may comprise a device housing. The device housing may contain the heater assembly, power supply and control circuitry. The housing may comprise an opening for receiving an aerosol-generating article. The opening may be connected to the aerosol outlet of the second heater casing of the heater assembly to allow for insertion of an aerosol-generating article into the heating chamber. The housing may comprising an air inlet. The air inlet may be connected to the air inlet of the first heater casing of the heater assembly.

The housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. The material is preferably light and non-brittle.

According to an example of the present disclosure, there is provided an aerosol-generating system comprising an aerosol-generating device according to any of the examples described above. The aerosol-generating system may comprise an aerosol-generating article comprising an aerosol-forming substrate.

According to an example of the present disclosure, there is provided an aerosol-generating system comprising: an aerosol-generating device according to any of the examples described above; and an aerosol-generating article comprising an aerosol-forming substrate.

As used herein, the term “aerosol-generating article” refers to an article comprising an aerosol-forming substrate that, when heated in an aerosol-generating device, releases volatile compounds that can form an aerosol. An aerosol-generating article is separate from and configured for combination with an aerosol-generating device for heating the aerosol-generating article.

The aerosol-generating article may be substantially cylindrical in shape. The aerosol-generating article may be substantially elongate. The aerosol-forming substrate may be substantially cylindrical in shape. The aerosol-forming substrate may be substantially elongate.

The aerosol-generating article may have a total length between approximately 30 mm and approximately 100 mm. The aerosol-generating article may have an external diameter between approximately 5 mm and approximately 12 mm. The aerosol-forming substrate may have a length of between approximately 10 mm and approximately 18 mm. Further, the diameter of the aerosol-forming substrate may be between approximately 5 mm and approximately 12 mm. The aerosol-generating article may comprise a filter plug. The filter plug may be located at the downstream end of the aerosol-generating article. The filter plug may be a cellulose acetate filter plug. The filter plug is approximately 7 mm in length in one embodiment, but may have a length of between approximately 5 mm to approximately 12 mm.

In one embodiment, the aerosol-generating article may have a total length of approximately 45 mm. The aerosol-generating article may have an external diameter of approximately 7.3 mm but may have an external diameter of between approximately 7.0 mm and approximately 7.4 mm. Further, the aerosol-forming substrate may have a length of approximately 12 mm. Alternatively, the aerosol-forming substrate may have a length of approximately 16 mm. The aerosol-generating article may comprise an outer paper wrapper. Further, the aerosol-generating article may comprise a separation between the aerosol-forming substrate and the filter plug. The separation may be approximately 21 mm or approximately 26 mm, but may be in the range of approximately 5 mm to approximately 28 mm. The separation may be provided by a hollow tube. The hollow tube may be a made from cardboard or cellulose acetate.

The aerosol-forming substrate may be a solid aerosol-forming substrate. Alternatively, the aerosol-forming substrate may comprise both solid and liquid components. The aerosol-forming substrate may comprise a tobacco-containing material containing volatile tobacco flavour compounds which are released from the substrate upon heating. Alternatively, the aerosol-forming substrate may comprise a non-tobacco material. The aerosol-forming substrate may further comprise an aerosol former. Examples of suitable aerosol formers are glycerine and propylene glycol.

If the aerosol-forming substrate is a solid aerosol-forming substrate, the solid aerosol-forming substrate may comprise, for example, one or more of: powder, granules, pellets, shreds, spaghettis, strips or sheets containing one or more of: herb leaf, tobacco leaf, fragments of tobacco ribs, reconstituted tobacco, homogenised tobacco, extruded tobacco and expanded tobacco. The solid aerosol-forming substrate may be in loose form, or may be provided in a suitable container or cartridge. Optionally, the solid aerosol-forming substrate may contain additional tobacco or non-tobacco volatile flavour compounds, to be released upon heating of the substrate. The solid aerosol-forming substrate may also contain capsules that, for example, include the additional tobacco or non-tobacco volatile flavour compounds and such capsules may melt during heating of the solid aerosol-forming substrate.

As used herein, homogenised tobacco refers to material formed by agglomerating particulate tobacco. Homogenised tobacco may be in the form of a sheet. Homogenised tobacco material may have an aerosol-former content of greater than 5% on a dry weight basis. Homogenised tobacco material may alternatively have an aerosol former content of between 5% and 30% by weight on a dry weight basis. Sheets of homogenised tobacco material may be formed by agglomerating particulate tobacco obtained by grinding or otherwise comminuting one or both of tobacco leaf lamina and tobacco leaf stems. Alternatively, or in addition, sheets of homogenised tobacco material may comprise one or more of tobacco dust, tobacco fines and other particulate tobacco by-products formed during, for example, the treating, handling and shipping of tobacco. Sheets of homogenised tobacco material may comprise one or more intrinsic binders, that is tobacco endogenous binders, one or more extrinsic binders, that is tobacco exogenous binders, or a combination thereof to help agglomerate the particulate tobacco; alternatively, or in addition, sheets of homogenised tobacco material may comprise other additives including, but not limited to, tobacco and non-tobacco fibres, aerosol-formers, humectants, plasticisers, flavourants, fillers, aqueous and non-aqueous solvents and combinations thereof.

In a particularly preferred embodiment, the aerosol-forming substrate comprises a gathered crimpled sheet of homogenised tobacco material. As used herein, the term ‘crimped sheet’ denotes a sheet having a plurality of substantially parallel ridges or corrugations. Preferably, when the aerosol-generating article has been assembled, the substantially parallel ridges or corrugations extend along or parallel to the longitudinal axis of the aerosol-generating article. This advantageously facilitates gathering of the crimped sheet of homogenised tobacco material to form the aerosol-forming substrate. However, it will be appreciated that crimped sheets of homogenised tobacco material for inclusion in the aerosol-generating article may alternatively or in addition have a plurality of substantially parallel ridges or corrugations that are disposed at an acute or obtuse angle to the longitudinal axis of the aerosol-generating article when the aerosol-generating article has been assembled. In certain embodiments, the aerosol-forming substrate may comprise a gathered sheet of homogenised tobacco material that is substantially evenly textured over substantially its entire surface. For example, the aerosol-forming substrate may comprise a gathered crimped sheet of homogenised tobacco material comprising a plurality of substantially parallel ridges or corrugations that are substantially evenly spaced-apart across the width of the sheet.

Optionally, the solid aerosol-forming substrate may be provided on or embedded in a thermally stable carrier. The carrier may take the form of powder, granules, pellets, shreds, spaghettis, strips or sheets. Alternatively, the carrier may be a tubular carrier having a thin layer of the solid substrate deposited on its inner surface, or on its outer surface, or on both its inner and outer surfaces. Such a tubular carrier may be formed of, for example, a paper, or paper like material, a non-woven carbon fibre mat, a low mass open mesh metallic screen, or a perforated metallic foil or any other thermally stable polymer matrix.

The solid aerosol-forming substrate may be deposited on the surface of the carrier in the form of, for example, a sheet, foam, gel or slurry. The solid aerosol-forming substrate may be deposited on the entire surface of the carrier, or alternatively, may be deposited in a pattern in order to provide a non-uniform flavour delivery during use.

Although reference is made to solid aerosol-forming substrates above, it will be clear to one of ordinary skill in the art that other forms of aerosol-forming substrate may be used with other embodiments. For example, the aerosol-forming substrate may be a liquid aerosol-forming substrate. If a liquid aerosol-forming substrate is provided, the aerosol-generating device preferably comprises means for retaining the liquid. For example, the liquid aerosol-forming substrate may be retained in a container or a liquid storage portion. Alternatively or in addition, the liquid aerosol-forming substrate may be absorbed into a porous carrier material. The porous carrier material may be made from any suitable absorbent plug or body, for example, a foamed metal or plastics material, polypropylene, terylene, nylon fibres or ceramic. The liquid aerosol-forming substrate may be retained in the porous carrier material prior to use of the aerosol-generating device or alternatively, the liquid aerosol-forming substrate material may be released into the porous carrier material during, or immediately prior to use. For example, the liquid aerosol-forming substrate may be provided in a capsule. The shell of the capsule preferably melts upon heating and releases the liquid aerosol-forming substrate into the porous carrier material. The capsule may optionally contain a solid in combination with the liquid.

Alternatively, the carrier may be a non-woven fabric or fibre bundle into which tobacco components have been incorporated. The non-woven fabric or fibre bundle may comprise, for example, carbon fibres, natural cellulose fibres, or cellulose derivative fibres.

According to an example of the present disclosure, there is provided a method of manufacturing a heater assembly for an aerosol-generating device. The method may comprise providing a first heater casing comprising an air inlet. The method may comprise providing a second heater casing comprising an aerosol outlet. The method may comprise providing a heating chamber for heating an aerosol-forming substrate. The method may comprise arranging the heating chamber such that it is in fluid communication with both the air inlet and the air outlet to define an airflow pathway through the heater assembly. The method may comprise providing a heater mount and mounting the heating chamber on the heater mount. The method may comprise providing a seal for sealing the airflow pathway. The method may comprise mounting the seal on the heater mount. The method may comprise spacing the seal apart from the heating chamber. The method may comprise attaching the first and second heater casings to each other to enclose the heating chamber and heater mount.

According to an example of the present disclosure, there is provided a method of manufacturing a heater assembly for an aerosol-generating device, the method comprising: providing a first heater casing comprising an air inlet; providing a second heater casing comprising an aerosol outlet; providing a heating chamber for heating an aerosol-forming substrate and arranging the heating chamber such that it is in fluid communication with both the air inlet and the air outlet to define an airflow pathway through the heater assembly; providing a heater mount and mounting the heating chamber on the heater mount; providing a seal for sealing the airflow pathway and mounting the seal on the heater mount such that it is spaced apart from the heating chamber; and attaching the first and second heater casings to each other to enclose the heating chamber and heater mount.

The heating chamber may be mounted on the heater mount by press-fitting. The heating chamber may be press-fitted into a recess on a second side of the heater mount.

The heating chamber may be attached to the second heater casing by press-fitting. The heating chamber may be press-fitted into a recess arranged on an internal surface of the second heater casing.

The first and second heater casings may be attached to each other using a fastener. A compressive force may be applied to the heater assembly prior to attaching the first and second heater casings to each other. The first and second heater casings may be attached to each other using a fastener whilst the compressive force is being applied. The compressive force may be released once the fastener has been attached.

Features described in relation to one of the above examples may equally be applied to other examples of the present disclosure.

The invention is defined in the claims. However, below there is provided a non-exhaustive list of non-limiting examples. Any one or more of the features of these examples may be combined with any one or more features of another example, embodiment, or aspect described herein.

Example Ex1: A heater assembly for an aerosol-generating device, the heater assembly comprising: a first heater casing comprising an air inlet; a second heater casing comprising an aerosol outlet; and a heating chamber for heating an aerosol-forming substrate, the heating chamber being in fluid communication with both the air inlet and aerosol outlet to define an airflow pathway through the heater assembly.

Example Ex2: A heater assembly according to Example Ex1, the heater assembly further comprising: a heater mount, the heating chamber being mounted on the heater mount; and a seal for sealing the airflow pathway; wherein the seal is mounted on the heater mount such that it is spaced apart from the heating chamber.

Example Ex3: A heater assembly according to Example Ex2, wherein the first and second heater casings are attached to each other and enclose the heating chamber and heater mount, and wherein the seal is arranged between the heater mount and an internal surface of one of the first and second heater casings.

Example Ex4: A heater assembly according to Example Ex2 or Ex3, wherein the seal is arranged between the heater mount and an internal surface of the first heater casing.

Example Ex5: A heater assembly according to any of Examples Ex2 to Ex4, wherein the seal is mounted on a first side of the heater mount and the heating chamber is mounted on a second side of the heater mount, the second side being axially opposite the first side.

Example Ex6: A heater assembly according to any of Examples Ex2 to Ex5, wherein the heater mount is arranged upstream of the heating chamber.

Example Ex7: A heater assembly according to any of Examples Ex2 to Ex6, wherein the heater mount is comprises a polymer.

Example Ex8: A heater assembly according to any of Examples Ex2 to Ex7, wherein the seal is arranged at a distance of at least 2 millimetres from the heating chamber.

Example Ex9: A heater assembly according to Example Ex8, wherein the seal is arranged at a distance of at least 4 millimetres from the heating chamber.

Example Ex10: A heater assembly according to Example Ex8 or Ex9, wherein the seal is arranged at a distance of between 4 millimetres and 6 millimetres from the heating chamber.

Example Ex11: A heater assembly according to any of Examples Ex2 to Ex10, wherein the seal comprises a resilient material.

Example Ex12: A heater assembly according to any of Examples Ex2 to Ex11, wherein the seal comprises a polymer having a Shore hardness between 30 A and 90 A.

Example Ex13: A heater assembly according to any of Examples Ex2 to Ex12, wherein the seal is compressed within the heater assembly.

Example Ex14: A heater assembly according to any of Examples Ex2 to Ex13, wherein the seal has an uncompressed thickness of between 0.5 mm and 2 mm.

Example Ex15: A heater assembly according to any of Examples Ex2 to Ex14, wherein the first heater casing, the second heater casing, the heating chamber and the heater mount each have an airflow channel, the airflow channels communicating to define the airflow pathway through the heater assembly.

Example Ex16: A heater assembly according to any preceding example, wherein the heating chamber comprises a tubular heating chamber.

Example Ex17: A heater assembly according to Example Ex16, wherein a diameter of the tubular heating chamber at each end of the tubular heating chamber is greater than a diameter of the tubular heating chamber in a region between the two ends of the tubular heating chamber.

Example Ex18: A heater assembly according to Example Ex16 or Ex17, wherein each end of the tubular heating chamber is flared or funnel-shaped.

Example Ex19: A heater assembly according to Example Ex18, wherein an axial length of the flared or funnel-shaped end of the tubular heating chamber is between 0.5 percent and 10 percent of the overall length of the tubular heating chamber.

Example Ex20: A heater assembly according to Example Ex16 or Ex17, wherein each end of the tubular heating chamber has a stepped or joggled profile.

Example Ex21: A heater assembly according to Example Ex20, wherein an axial length of the stepped or joggled end of the tubular heating chamber is between 0.5 percent and 10 percent of the overall length of the tubular heating chamber.

Example Ex22: An aerosol-generating device comprising: a heater assembly according to any of the preceding examples; and a power supply for supplying electrical power to the heater assembly.

Example Ex23: A method of manufacturing a heater assembly for an aerosol-generating device, the method comprising: providing a first heater casing comprising an air inlet; providing a second heater casing comprising an aerosol outlet; providing a heating chamber for heating an aerosol-forming substrate and arranging the heating chamber such that it is in fluid communication with both the air inlet and the air outlet to define an airflow pathway through the heater assembly; providing a heater mount and mounting the heating chamber on the heater mount; providing a seal for sealing the airflow pathway and mounting the seal on the heater mount such that it is spaced apart from the heating chamber; and attaching the first and second heater casings to each other to enclose the heating chamber and heater mount.

Example Ex24: A method according to Example Ex23, wherein the heating chamber is mounted on the heater mount by press-fitting.

Example Ex25: A method according to Example Ex23 or Ex24, wherein the heating chamber is attached to the second heater casing by press-fitting.

Examples will now be further described with reference to the figures in which:

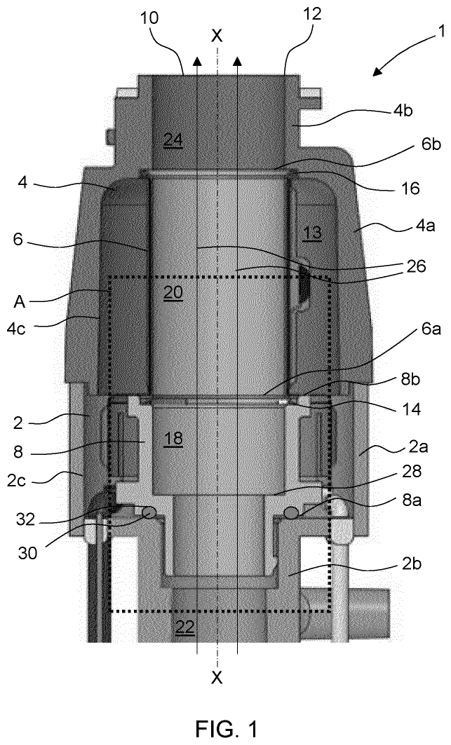

FIG. 1 is a longitudinal cross-section of a heater assembly according to an example of the present disclosure.

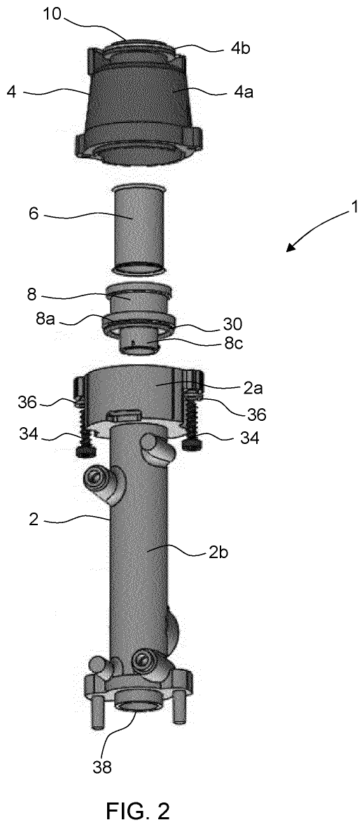

FIG. 2 is an exploded perspective view of the heater assembly of FIG. 1 prior to assembly showing the components of the heater assembly axially spaced apart.

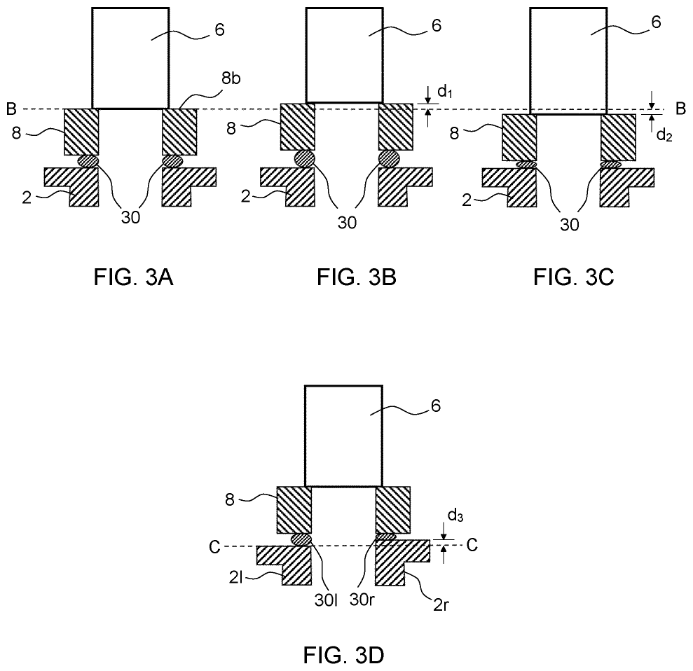

FIGS. 3A to 3C are schematic cross-sectional views of the parts of the heater assembly contained within the dotted box labelled A in FIG. 1 showing some ways in which the seal of the heater assembly helps to absorb lengthwise tolerances.

FIG. 3D is a schematic view of the parts of the heater assembly contained with the dotted box labelled A in FIG. 1 showing how the seal of the heater assembly helps to absorb tilt tolerances.

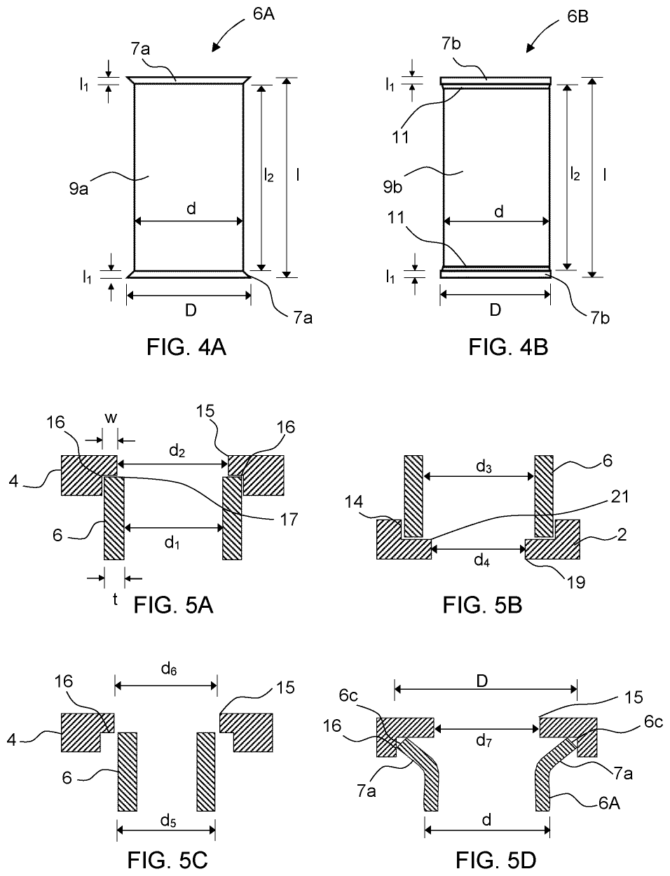

FIGS. 4A and 4B are side views of two example heating chambers for use in a heater assembly according to the present disclosure.

FIGS. 5A to 5C are schematic cross-sectional partial views of known tubular heating chambers showing problems which can occur due to manufacturing tolerances as a result of press-fitting of heating chambers into a heater casing.

FIG. 5D is a schematic cross-sectional view of an upper part of the heating chamber of FIG. 4A showing its press-fit engagement in a recess of a heater casing.

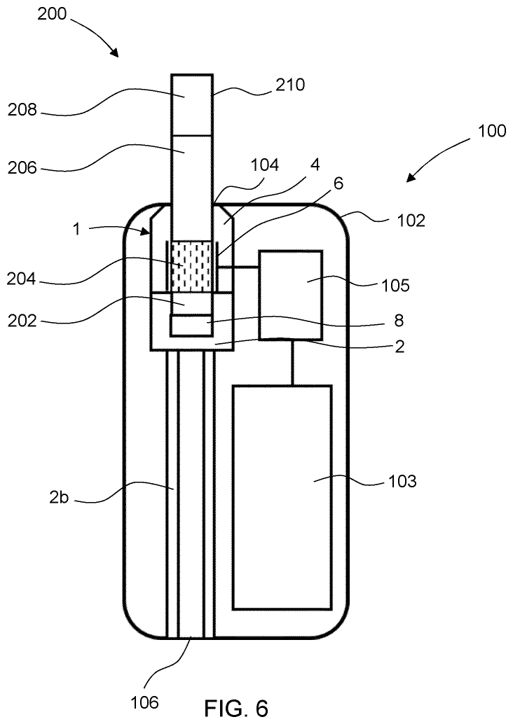

FIG. 6 is a schematic cross-sectional view showing the interior of an aerosol-generating device according to an example of the present disclosure and an aerosol-generating article received within the aerosol-generating device.

Referring to FIG. 1, this shows a longitudinal cross-section of a heater assembly 1 comprising a first heater casing 2, a second heater casing 4, a heating chamber 6 for heating an aerosol-forming substrate and a heater mount 8. The first heater casing 2 comprises a first hollow shell section 2a and a first tubular section 2b. The first hollow shell section 2a has an internal cavity 2c that surrounds the heater mount 8. An air inlet (not shown) is arranged at a distal end of a first tubular section 2b, which first tubular section 2b extends distally away from the first hollow shell section 2a in a direction parallel to a longitudinal axis X-X of the heater assembly 1.

The second heater casing 4 comprises a second hollow shell section 4a and a second tubular section 4b. The second hollow shell section 4a has an internal cavity 4c that surrounds the heating chamber 6. An aerosol outlet 10 is arranged at a proximal end of the second tubular section 4b, which second tubular section 4b extends proximally away from the second hollow shell section 4a in a direction parallel to a longitudinal axis X-X of the heater assembly 1. The aerosol outlet 10 is defined by an opening 12 which is configured to receive an aerosol-generating article (not shown). Aerosol exits the opening 10 via an aerosol-generating article received in the heating chamber 6. The first 2 and second 4 heater casings are attached to each other and enclose the heating chamber 6 and heater mount 8.

The heating chamber 6 comprises a tubular heating chamber made from stainless steel tube. The ends 6a, 6b of the tubular heating chamber 6 are flared or funnel-shaped, the reasons for which are discussed in more detail below. A heating element (not shown) is arranged around an exterior surface of the heating chamber to heat the heating chamber 6, which in turn heats an aerosol-forming substrate (not shown) received within an internal space of the tubular heating chamber 6. The heating element comprises heat-resistant flexible polyimide film having resistive heating tracks which typically form a serpentine pattern on the film. The resistive heating tracks are connected to an electrical power supply (not shown) and generate heat when an electric current is passed through them. Although not shown in FIG. 1, the heating element is arranged around substantially the entire length of the tubular heating chamber 6, with the exception of the funnel-shaped ends, to heat substantially the entire length of the tubular heating chamber 6.

The first 2 and second 4 heater casings are made from polyether ether ketone (PEEK) due to its advantageous mechanical and heat-insulating properties. The walls of the internal cavities 2c and 4c of the first and second heater casings respectively are radially spaced from the heating chamber 6 and heater mount 8 to define a hollow airspace 13 around the heating chamber 6 and heater mount 8. The hollow airspace 13 helps to thermally insulate the heating chamber 6 which helps to reduce heat losses from the heating chamber 6 and also helps to reduce heat transfer to an exterior of the heater assembly 1 and aerosol-generating device.

The heater mount 8 is arranged within the first heater casing 2. A first side 8a of the heater mount 8 is arranged adjacent a base or distal end wall of the first hollow shell section 2a. The heating chamber 6 is mounted on a second side 8b of the heater mount 8, which second side 8b is axially opposite the first side 8a in a direction parallel to the longitudinal axis X-X of the heater assembly 1. A first end 6a of the heating chamber 6 is press-fit within a first recess 14 formed in the second side 8b of the heater mount 8. A second end 6b of the heating chamber 6 is press-fit within a second recess 16 formed in the second heater casing 4 at a top or proximal end wall of the second hollow shell section 4a and at a distal end of the second tubular section 4b. The heater mount 8 is made from PEEK due to its advantageous mechanical and heat-insulating properties.

The heater mount 8 has an internal airflow channel 18 which extends axially along the length of the heater mount 8 in a direction parallel to a longitudinal axis X-X of the heater assembly 1. The airflow channel 18 of the heater mount 8 is in fluid communication with an airflow channel 20 defined by the internal space of the tubular heating chamber 6, which airflow channel 20 extends axially along the length of the heating chamber 6 in a direction parallel to a longitudinal axis X-X of the heater assembly 1. In addition, the first tubular section 2b of the first heater casing 2 has an airflow channel 22 and the second tubular section 4b of the second heater casing 4 has an airflow channel 24. The airflow channels 22, 18, 20 and 24 of the first tubular section 2b, heater mount 8, tubular heating chamber 6 and second tubular section 4b respectively are in fluid communication with each other to define an airflow pathway 26 through the heater assembly 1 between the air inlet (not shown) and the aerosol outlet 10. The heating chamber 6 is therefore in fluid communication with both the air inlet and the aerosol outlet 10.

The heater mount 8 has a step or stop 28 formed in an internal surface of the heater mount 8 within its airflow channel 18. The stop 28 is arranged to engage a distal end of an aerosol-generating article (not shown) to inhibit movement of the distal end of the aerosol-generating article beyond the stop 28 and to accurately locate the aerosol-forming substrate provided within the aerosol-generating article within the heating chamber 6.

An elastomeric polymer seal 30 in the form of an O-ring made from ethylene propylene diene monomer (EPDM) rubber is mounted on the heater mount 8. The seal 30 is mounted on a first side 8a of the heater mount 8 between the heater mount 8 and a distal end wall of the first hollow shell section 2a of the first heater casing 2. The O-ring seal circumscribes the airflow pathway 26 through the heater assembly 1. A recess 32 is formed in the first side 8a of the heater mount 8 to locate the seal 30. The seal 30 has a Shore hardness of 70 A, as determined by technical standard ISO868 Type A. This hardness has been found to be sufficiently soft to absorb lengthwise and tilt tolerances, as discussed in more detail below, but also sufficiently hard to exert force on the heater assembly 1 to provide for sealing of the airflow pathway 26 and integrity of the heater assembly 1. The seal 30 has an uncompressed thickness or diameter of 1 millimetre. This thickness has also been found to be suitable for absorbing lengthwise and tilt tolerances and to exert force on the heater assembly 1 to provide for sealing of the airflow pathway 26 and integrity of the heater assembly 1.

By mounting the seal 30 on the first side 8a of the heater mount 8 and mounting the heating chamber 6 on the second side 8b of the heater mount 8, the seal 30 is spaced apart or distanced from the heating chamber 6. In this arrangement, at least a portion of the heater mount 8 is arranged between the seal 30 and the heating chamber 6. This reduces heat transfer to the seal 30 and helps to maintain the seal 30 at a lower temperature than the heating chamber 6. As mentioned above, the heater mount is made from PEEK, which has a lower thermal conductivity than the heating chamber which is made from stainless steel. This helps to further reduce heat transfer to the seal 30 and maintain the seal 30 at a lower temperature than the heating chamber. Therefore, in the arrangement of FIG. 1, the seal 30 is at a lower temperature than if it were in direct contact with the heating chamber which helps to maintain the integrity of the seal 30 to provide improved sealing.

The seal 30 is resilient and is compressed to some extent when the heater assembly 1 is assembled. The resilience of the seal 30 exerts an axial force on the heater mount 8 in a direction parallel to the longitudinal axis X-X of the heater assembly 1. Since the heater mount 8 is axially aligned with the heating chamber 6, which in turn is axially aligned with the second tubular section 4b, the seal 30 assists in urging these components into sealing engagement with each other to seal the airflow pathway 26 and reduce the likelihood of aerosol leaking out of the airflow pathway 26 at a point of intersection between two components. The seal 30 also provides a gas-tight seal between the heater mount 8 and the first heater casing 2.

FIG. 2 shows an exploded perspective view of the heater assembly 1 of FIG. 1 prior to assembly. The components of the heater assembly 1, that is, the first heater casing 2, heater mount 8, seal 30, heating chamber 6 and second heater casing 4, are shown axially spaced apart in FIG. 2. To assemble the heater assembly 1, the seal 30 is first mounted on a first side 8a of the heater mount 8. The heater mount 8 and seal 30 subassembly is then mounted within the first hollow shell section 2a of the first heater casing 2. A hollow plug 8c which extends distally from the first side 8a of the heater mount 8 is press-fit into an internal recess (not shown) formed in a proximal end of the first tubular section 2b.

The heating chamber 6 is then press-fit into an internal recess (not shown in FIG. 2, but see second recess 16 in FIG. 1) formed in proximal end wall of the second hollow shell section 4a of the second heater casing 4. A guide (not shown) is inserted internally through the second tubular section 4b of the second heater casing 4 and through the internal space within the heating chamber 6 to maintain the components in axial alignment. The second heater casing 4 and heating chamber 6 subassembly is then mounted on the subassembly comprising the first heater casing 2, seal 30 and heater mount 8. A distal end of the guide is inserted into the internal airflow channel (not shown) of the heater mount 8 to maintain the components in alignment. The first 2 and second 4 heater casings are then attached to each other using two screws 34 and washers 36. The guide is then removed. Attaching the first 2 and second 4 heater casings compresses the seal 30 which then exerts an axial force, as discussed above, to keep the components of the heater assembly 1 in axial sealing engagement and to seal the airflow pathway through the heater assembly. The airflow pathway is therefore sealed between an air inlet 38 arranged at a distal end of the first tubular section 2b of the first heater casing 2 and an aerosol outlet 10 arranged at a proximal end of the second heater casing 4.

FIGS. 3A to 3C are schematic cross-sectional views of the parts of the heater assembly 1 contained within the dotted box labelled A in FIG. 1 and show some ways in which the seal of the heater assembly helps to absorb lengthwise tolerances. Referring to FIG. 3A, this shows a lower portion of the tubular heating chamber 6, engaged with an upper or second side 8b of the heater mount 8. The seal 30 is arranged at a lower or first side of the heater mount 8 and between the heater mount 8 and the first heater casing 2. The seal 30 has a circular cross-section in a longitudinal plane in its uncompressed state but is axially compressed to some extent in a direction parallel to the longitudinal axis X-X (see FIG. 1) of the heater assembly when the heater assembly is assembled. It is therefore shown in FIG. 3A having a flattened or oval cross-section to illustrate the effect of the axial compression.

In the example of FIG. 3A, the tubular heating chamber 6, heater mount 8 and second heating casing 2 are the correct specified design length. A horizontal dashed line B-B marks the level of the surface at which the heating chamber 6 and heater mount 8 intersect in FIG. 3A. Horizontal line B-B also extends across FIGS. 3B and 3C and acts as a datum to show where the heating chamber 6 and heater mount 8 should intersect if the heating chamber 6 is the correct length.

In FIG. 3B, the heating chamber 6 is too short, that is, the length of the heating chamber 6 is less than its specified design length by a distance d₁. However, its length is still within manufacturing tolerances. In this situation, the seal 30 is less compressed in an axial direction compared to its compressed state in FIG. 3A by an amount corresponding to distance d₁ in order to absorb the shortage of length caused by the lengthwise manufacturing tolerance. In its less compressed state in FIG. 3B, the seal still has sufficient compression to urge the components of the heater assembly into axial engagement to seal the airflow pathway through the heater assembly and still provides an air-tight seal between the heater mount 8 and first heater casing 2.

In FIG. 3C, the heating chamber 6 is too long, that is, the length of the heating chamber 6 is more than its specified design length by a distance d₂. However, its length is still within manufacturing tolerances. In this situation, the seal 30 is more compressed in an axial direction compared its compressed state in FIG. 3A by an amount corresponding to distance d₂ in order to absorb the excess length caused by the lengthwise manufacturing tolerance. In its more compressed state, the seal is still able to urge the components of the heater assembly into axial engagement to seal the airflow pathway through the heater assembly and still provides an air-tight seal between the heater mount 8 and first heater casing 2.

It will be appreciated that the resilience and thickness of the seal 30 can be used to compensate for lengthwise tolerances of other components, for example, the heater mount 8 or second heating casing 2, in addition to the heating chamber 6 in a similar manner to that shown in FIGS. 3B and 3C.

FIG. 3D is a schematic cross-sectional view of the parts of the heater assembly 1 contained within the dotted box labelled A in FIG. 1 similar to FIGS. 3A to 3C. This figure shows how the seal 30 of the heater assembly helps to absorb tilt tolerances. In FIG. 3D, the right-hand side 2r of the first heater casing 2 is at a different axial level to the left-hand side 2l of the first heater casing 2 by a distance d₃ in a direction parallel to a longitudinal axis X-X (see FIG. 1) of the heater assembly. This is due to a manufacturing tilt tolerance and would cause the heater mount 8 and heating chamber 6 to tilt if the heater mount 8 were mounted directly on the first heater casing 2. A dashed line C-C shows the correct specified design height or level of the first heater casing. In this situation, the left-hand side 30l of the seal 30 has the standard amount of compression as shown in FIG. 3A. The right-hand side 30r of the seal 30 is more compressed in an axial direction compared to the left-hand side 30r of the seal 30 by an amount corresponding to distance d₃ in order to absorb the difference in level caused by the tilt manufacturing tolerance. In this state, the seal is still able to urge the components of the heater assembly into axial engagement to seal the airflow pathway through the heater assembly and still provides an air-tight seal between the heater mount 8 and first heater casing 2.

It should be noted that FIGS. 3A to 3D are schematic and are not to scale. For clarity, the figures have been simplified by omitting some detail and altering or exaggerating the size of features.

FIGS. 4A and 4B are side views of two example heating chambers for use in a heater assembly according to the present disclosure. Referring to FIG. 4A, this shows a first example heating chamber 6A. The heating chamber 6A comprises a stainless steel tube having a circular cross-section. A hollow internal space within the tubular heating chamber 6A has an internal diameter substantially corresponding to an external diameter of an aerosol-generating article so that the tubular heating chamber 6A can receive an aerosol-generating article (not shown) within the internal space. A portion 7a of the heating chamber 6A at each end of the heating chamber 6A is flared outwards to form a funnel shape at each end of the heating chamber 6A. The flared portions 7a each have a length I₁ and the percentage of the overall length l of the heating chamber 6A made up by each length I₁ of the flared portions may be in the range between 1 and 5 percent. The flared end portions 7a of the heating chamber 6A each form an angle of about 45 degrees with the longitudinal axis of the heating chamber 6A. As a result of the flared end portions 7a, the external diameter D at the two ends of the heating chamber 6A is larger than the external diameter d of the heating chamber 6A in between the two flared end portions 7a.

A portion 9a of the heating chamber 6A in between the two flared end portions 7a has straight sides, which are parallel to the longitudinal axis of the heating chamber 6A. The straight portion 9a of the heating chamber 6A has a length 12, which substantially corresponds to the length of an aerosol-forming substrate provided in an aerosol-generating article configured to be received within the heating chamber 6A. Substantially all of the length 12 of the straight portion 9a of the heating chamber 6A is circumscribed by a flexible heating element (not shown but described above in relation to FIG. 1). The flared portions 7a of the heating chamber 6A are not circumscribed by the heating element and act as spacers between the ends of the heating element and the components which hold the heating chamber 6A, that is, the heater mount and second heater casing, and help to prevent direct contact between these components and the heating element.

Referring to FIG. 4B, this shows a second example heating chamber 6B. The heating chamber 6B has essentially the same construction as the heating chamber 6A in FIG. 4A with the exception that, instead of flared end portions, heating chamber 6B has stepped or joggled end portions 7b. That is, a portion 7b of the heating chamber 6B at each end of the heating chamber 6B is stepped or joggled radially outwards to form a step at each end of the heating chamber 6B. The stepped portions 7b each have a length I₁ and the percentage of the overall length l of the heating chamber 6B made up by each length I₁ of the stepped portions may be in the range between 1 and 5 percent. As a result of the stepped end portions 7b, the external diameter D at the two ends of the heating chamber 6B is larger than the external diameter d of the heating chamber 6B in between the two stepped end portions 7b.

A portion 9b of the heating chamber 6B in between the two stepped end portions 7b has straight sides, which are parallel to the longitudinal axis of the heating chamber 6B. The straight portion 9b of the heating chamber 6B has a length 12, which substantially corresponds to the length of an aerosol-forming substrate provided in an aerosol-generating article configured to be received within the heating chamber 6B. Substantially all of the length 12 of the straight portion 9b of the heating chamber 6B is circumscribed by a flexible heating element (not shown but described above in relation to FIG. 1). The stepped portions 7b of the heating chamber 6B are not circumscribed by the heating element and act as spacers between the ends of the heating element and the components which hold the heating chamber 6B, that is, the heater mount and second heater casing, and help to prevent direct contact between these components and the heating element. The heating chamber 6B also comprises a transition portion 11 in between each stepped portion 7b and the straight portion 9b to provide a sloped or curved transition between the external diameter D of each stepped portion and the external diameter d of the straight portion.

FIGS. 5A to 5C are schematic cross-sectional views of parts of known tubular heating chambers having straight tubular walls showing problems which can occur due to manufacturing tolerances during the press-fitting of such heating chambers into engagement with a heater casing. Manufacturing tolerances can result in the dimensions of components being bigger or small than the specified design length, which can lead to problems with connecting close-fitting components. Achieving very precise manufacturing tolerances is more challenging in rapid manufacturing techniques such as injection moulding.

Referring to FIG. 5A, this shows an upper part of a known or conventional tubular heating chamber 6 press-fitted into a recess 16 in an upper heater casing 4. The entire length of the tubular heating chamber 6 is straight, that is, it has a constant outside diameter along its entire length, and the tubular heating chamber 6 does not have a flared or stepped end portion like the tubular heating chambers 6A and 6B in FIGS. 4A and 4B. As can be seen in FIG. 5A, the internal diameter d₁ of the heating chamber 6 is less than the internal diameter d₂ of an opening 15 in the heater casing 4 through which an aerosol-generating article passes during insertion of the aerosol-generating article into the heating chamber 6. As a result, part of the thickness t of each of the walls, that is, an end surface, of the heating chamber 6 protrudes into the internal space defined by internal diameter d₂ of the opening 15. This forms a sharp step 17 at the opening 15 which may damage an aerosol-generating article when an aerosol-generating article is inserted through opening 15 or may prevent the aerosol-generating article from being inserted. A similar situation may arise if the width w of the recess 16 is less than the thickness t of the walls of the tubular heating chamber 6. In this case, there is not sufficient space within recess 16 to receive the ends of the tubular heating chamber 6 and consequently the ends will protrude into the internal space defined by internal diameter d₂ of the opening 15.

It will be appreciated that a similar situation to that shown in FIG. 5A may arise at a lower or upstream end of the tubular heating chamber 6. Sharp steps at an upstream end of the heating chamber may suffer the problem that debris or deposits build up in the crevices formed by the step, which can be difficult to remove or clean with a cleaning tool.

FIG. 5B shows a lower part of a known or conventional tubular heating chamber 6 press-fitted into a recess 14 of a lower heater casing 2. As in FIG. 5A, the entire length of the tubular heating chamber 6 is straight. The internal diameter d₃ of the heating chamber 6 is greater than an internal diameter d₄ of an opening 19 formed in the lower heater casing 2 through which a portion of the aerosol-generating article protrudes when an aerosol-generating article is properly located in the heating chamber 6. As a result a sharp step 21 is formed at the opening 19 which may damage an aerosol-generating article when an aerosol-generating article is passes through opening 19 or may prevent the aerosol-generating article from being fully inserted.

It will be appreciated that a similar situation to that shown in FIG. 5B may arise at an upper or downstream end of the tubular heating chamber 6. Sharp steps at a downstream end of the heating chamber may suffer the problem that debris or deposits build up in the crevices formed by the step, which can be difficult to remove or clean with a cleaning tool.

FIG. 5C shows an upper part of a known or conventional tubular heating chamber 6 which is to be press-fitted into a recess 16 in an upper heater casing 4. As in FIGS. 5A and 5C, the entire length of the tubular heating chamber 6 is straight. The external diameter d₅ of the tubular heating chamber 6 is less than the internal diameter of an opening 15 in the heater casing 4 through which an aerosol-generating article passes during insertion of the aerosol-generating article into the heating chamber 6. As a result, a press-fit is not possible in this situation because the tubular heating chamber 6 would simply pass through the opening 15.

FIG. 5D is a schematic cross-sectional view of an upper part of the tubular heating chamber 6A of FIG. 4A. As described above, the tubular heating chamber 6A has walls with a funnel-shaped or flared end portion 7a. The flared end portion 7a has been press-fitted into a recess 16 of the second heater casing 4. The external diameter D of the flared end portion 7a is larger than the external diameter d of the part of the tubular heating chamber 6A between the two flared end portions 7a (only one flared end portion is visible in FIG. 5D). The external diameter D of the flared end portion 7a is also larger than the internal diameter d₇ of an opening 15 in the heater casing 4 through which an aerosol-generating article passes during insertion of the aerosol-generating article into the heating chamber 6. The external diameter D of the flared end portion 7a is larger than the internal diameter d₇ of the opening 15 even when the radial or lateral manufacturing tolerances of the internal diameter d₇ are taken into account.

The arrangement of FIG. 5D significantly reduces the likelihood of a part of the end surfaces 6c of the walls of the tubular heating chamber 6A protruding within diameter d₇ and the airflow pathway cross-section which is defined in FIG. 5D by the diameter d₇. Furthermore, the end surfaces 6c of the walls of the tubular heating chamber 6A are angled away from the airflow pathway cross-section defined by the diameter d₇, which further reduces the likelihood of a part of the end surfaces 6c of the walls of the tubular heating chamber 6A protruding into the airflow pathway. The arrangement of FIG. 5D and, in particular, the use of a tubular heating chamber 6A with flared or funnel-shaped end portions 7a, allows for the use of components with greater radial or lateral tolerances and is therefore suited to rapid manufacturing techniques. The arrangement of FIG. 5D also significantly reduces the risk of damage to the aerosol-generating article upon insertion of the aerosol-generating article into the heating chamber 6A.

It will be appreciated that the tubular heating chamber 6B of FIG. 4B could also be used in the arrangement of FIG. 5D instead of heating chamber 6A to achieve the same benefits. The larger external diameter D at the stepped end portions 7b of heating chamber 6B reduces the likelihood of a part of the end surfaces of the walls of the tubular heating chamber 6B protruding within diameter d₇ of FIG. 5D and into the airflow pathway. The heating chamber 6B also allows for the use of components with greater radial or lateral tolerances and reduces the risk of damage to the aerosol-generating article upon insertion of the aerosol-generating article into the heating chamber 6B.

It should be noted that FIGS. 5A to 5D are schematic and are not to scale. For clarity, the figures have been simplified by omitting some detail and altering or exaggerating the size of features.

FIG. 6 is a schematic cross-sectional view showing the interior of an aerosol-generating device 100 and an aerosol-generating article 200 received within the aerosol-generating device 100. Together, the aerosol-generating device 100 and aerosol-generating article 200 form an aerosol-generating system. In FIG. 6, the aerosol-generating device 100 is shown in a simplified manner. In particular, the elements of the aerosol-generating device 100 are not drawn to scale. Furthermore, elements that are not relevant for the understanding of the aerosol-generating device 100 have been omitted.

The aerosol-generating device 100 comprises a housing 102 containing the heater assembly 1 of FIG. 1, a power supply 103 and control circuitry 105. In FIG. 6, the first heater casing 2, heating chamber 6, heater mount 8 and second heater casing 4 are shown. As described above in relation to FIG. 1, the heating chamber 6 has a flexible heating element (not shown) arranged around it for heating the heating chamber 6. The power supply 103 is a battery and, in this example, it is a rechargeable lithium ion battery. The control circuitry 105 is connected to both the power supply 103 and the heating element and controls the supply of electrical energy from the power supply 103 to the heating element to regulate the temperature of the heating element.

The housing 102 comprises an opening 104 at a proximal or mouth end of the aerosol-generating device 100 through which an aerosol-generating article 200 is received. The opening 104 is connected to the opening 12 in the heater assembly 1 of FIG. 1, via which aerosol exits the heater assembly 1. However, it will be appreciated that aerosol largely exits the heater assembly 1 and the aerosol-generating device 100 via the aerosol-generating article 200. The housing 102 further comprises an air inlet 106 at a distal end of the aerosol-generating device 100. The air inlet 106 is connected to the air inlet arranged at a distal end of the first tubular section 2b of the first heater casing 2. The first tubular section 2b delivers air from the air inlet 106 to the heating chamber 6.

The aerosol-generating article 200 comprises an end plug 202, an aerosol-forming substrate 204, a hollow tube 206, and a mouthpiece filter 208. Each of the aforementioned components of the aerosol-generating article 100 is a substantially cylindrical element, each having substantially the same diameter. The components are arranged sequentially in abutting coaxial alignment and are circumscribed by an outer paper wrapper 210 to form a cylindrical rod. The aerosol-forming substrate 204 is a tobacco rod or plug comprising a gathered sheet of crimped homogenised tobacco material circumscribed by a wrapper (not shown). The crimped sheet of homogenised tobacco material comprises glycerine as an aerosol-former. The end plug 202 and mouthpiece filter 208 are formed from cellulose acetate fibres.

A distal end of the aerosol-generating article 200 is inserted into the aerosol-generating device 100 via the opening 104 in the housing 102 and pushed into the aerosol-generating device 100 until it engages a stop (not shown in FIG. 6) arranged on the heater mount 8, at which point it is fully inserted. The stop helps to correctly locate the aerosol-forming substrate 204 within the heating chamber 6 so that the heating chamber 6 can heat the aerosol-forming substrate 204 to form an aerosol.

The aerosol-generating device 100 may further comprise: a sensor (not shown) for detecting the presence of the aerosol-generating article 200; a user interface (not shown) such as a button for activating the heating element; and a display or indicator (not shown) for presenting information to a user, for example, remaining battery power, heating status and error messages.

In use, a user inserts an aerosol-generating article 200 into the aerosol-generating device 100, as shown in FIG. 6. The user then starts a heating cycle by activating the aerosol-generating device 100, for example, by pressing a switch to turn the device on. In response, the control circuitry 105 controls a supply of electrical power from the power supply 103 to the heating element (not shown) to heat the heating element, which in turn heats the heating chamber 6. During a heating cycle, the heating element heats the heating chamber 6 to a predefined temperature, or to a range of predefined temperatures according to a temperature profile. A heating cycle may last for around 6 minutes. The heat from the heating chamber 6 is transferred to the aerosol-forming substrate 204 which releases volatile compounds from the aerosol-forming substrate 204. The volatile compounds form an aerosol within an aerosolisation chamber formed by the hollow tube 206. During a heating cycle, the user places the mouthpiece filter 208 of the aerosol-generating article 200 between the lips of their mouth and takes a puff or inhales on the mouthpiece filter 208. The generated aerosol is then drawn through the mouthpiece filter 102 into the mouth of the user.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A+5 percent (5%) of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-20. (canceled)

21. A heater assembly for an aerosol-generating device, the heater assembly comprising:
a first heater casing comprising an air inlet;
a second heater casing comprising an aerosol outlet; and
a heating chamber configured to heat an aerosol-forming substrate, the heating chamber being in fluid communication with both the air inlet and the aerosol outlet and being configured to define an airflow pathway through the heater assembly;
a heater mount, the heating chamber being mounted on the heater mount; and
a seal configured to seal the airflow pathway,
wherein the seal is mounted on the heater mount such that the seal is spaced apart from the heating chamber, and
wherein the seal is mounted on a first end of the heater mount and the heating chamber is mounted on a second end of the heater mount, the second end being axially opposite the first end.

22. The heater assembly according to claim 21,
wherein the first and the second heater casings are attached to each other and enclose the heating chamber and the heater mount, and
wherein the seal is arranged between the heater mount and an internal surface of one of the first and the second heater casings.

23. The heater assembly according to claim 21, wherein the seal is arranged between the heater mount and an internal surface of the first heater casing.

24. The heater assembly according to claim 21, wherein the heater mount is arranged upstream of the heating chamber.

25. The heater assembly according to claim 21, wherein the heater mount comprises a polymer.

26. The heater assembly according to claim 21, wherein the seal is disposed at a distance of between 4 millimetres and 6 millimetres from the heating chamber.

27. The heater assembly according to claim 21, wherein the seal comprises a polymer having a Shore hardness between 30 A and 90 A.

28. The heater assembly according to claim 21, wherein the seal has an uncompressed thickness of between 0.5 mm and 2 mm.

29. The heater assembly according to claim 21, wherein the first heater casing, the second heater casing, the heating chamber, and the heater mount each have an airflow channel, the airflow channels communicating to define the airflow pathway through the heater assembly.

30. The heater assembly according to claim 21, wherein the heating chamber comprises a tubular heating chamber.

31. The heater assembly according to claim 30, wherein a diameter of the tubular heating chamber at each end of the tubular heating chamber is greater than a diameter of the tubular heating chamber in a region between said each end of the tubular heating chamber.

32. The heater assembly according to claim 30, wherein each end of the tubular heating chamber is flared or funnel shaped.

33. The heater assembly according to claim 32, wherein an axial length of said each flared or funnel-shaped end of the tubular heating chamber is between 0.5 percent and 10 percent of an overall length of the tubular heating chamber.

34. The heater assembly according to claim 31, wherein said each end of the tubular heating chamber has a stepped or joggled profile.

35. The heater assembly according to claim 34, wherein an axial length of said each stepped or joggled end of the tubular heating chamber is between 0.5 percent and 10 percent of an overall length of the tubular heating chamber.

36. The heater assembly according to claim 21, wherein the heating chamber is further configured to receive at least a portion of an aerosol-generating article.

37. An aerosol-generating device, comprising:
a heater assembly according to claim 21; and
a power supply configured to supply electrical power to the heater assembly.

38. A method of manufacturing a heater assembly for an aerosol-generating device, the method comprising:
providing a first heater casing comprising an air inlet;
providing a second heater casing comprising an aerosol outlet;
providing a heating chamber for heating an aerosol-forming substrate and arranging the heating chamber such that the heating chamber is in fluid communication with both the air inlet and the air outlet to define an airflow pathway through the heater assembly;
providing a heater mount and mounting the heating chamber on the heater mount;
providing a seal for sealing the airflow pathway and mounting the seal on the heater mount such that the seal is spaced apart from the heating chamber, wherein the seal is mounted on a first end of the heater mount and the heating chamber is mounted on a second end of the heater mount, the second end being axially opposite the first end; and
attaching the first and the second heater casings to each other to enclose the heating chamber and heater mount.
